(19) United States
(12) Patent Application Publication
(10) Pub. No.: US 2021/0264378 A1
(43) Pub. Date: Aug. 26, 2021

(54) DISPLAY DEVICE, ELECTRONIC WATCH, DISPLAY METHOD, AND NON-TRANSITORY RECORDING MEDIUM

(71) Applicant: CASIO COMPUTER CO., LTD., Tokyo (JP)

(72) Inventors: Asahi KUROTAKI, Tokyo (JP); Takaharu ASHIKAGA, Tokyo (JP)

(73) Assignee: CASIO COMPUTER CO., LTD., Tokyo (JP)

(21) Appl. No.: 17/179,569

(22) Filed: Feb. 19, 2021

(30) Foreign Application Priority Data
Feb. 25, 2020 (JP) 2020-029027

(51) Int. Cl. G06Q 10/10; G04G 9/04; G06F 1/16; G06F 15/02

(52) U.S. Cl. CPC G06Q 10/1095; G06F 15/0266; G06F 1/163; G04G 9/04

(57) ABSTRACT

A display device includes at least one processor. The processor acquires a plurality of pieces of schedule information each including information of a starting time and information of an ending time. When first schedule information and second schedule information, respective periods of which at least partially overlap each other, each period ranging from the starting time to the ending time, exist, the processor selects one piece of schedule information out of the first schedule information and the second schedule information, based on the starting time or the ending time set to each piece of the first schedule information and the second schedule information. The processor executes display based on the selected schedule information.

### CROSS-REFERENCE TO RELATED APPLICATION

This application is based upon and claims the benefit of priority under 35 USC 119 of Japanese Patent Application No. 2020-029027, filed on Feb. 25, 2020, the entire disclosure of which, including the description, claims, drawings, and abstract, is incorporated herein by reference in its entirety.

### FIELD

This application relates generally to a display device, an electronic watch, a display method, and a non-transitory recording medium.

### BACKGROUND

Display devices or electronic watches displaying times related to schedules for schedule management and the like have been used. For example, Unexamined Japanese Patent Application Publication No. 2011-67281 discloses a display device displaying, on a display area, at least one of a reason for a temporary room exit entailing suspension of measurement of biological information of a patient, a room exiting time, a scheduled measurement resumption time, and present lapse information.

### SUMMARY

A display device according to one embodiment is a display device including at least one processor,

wherein the processor
acquires a plurality of pieces of schedule information each including information of a starting time and information of an ending time,
when first schedule information and second schedule information, respective periods of which at least partially overlap each other, each period ranging from the starting time to the ending time, exist, selects one piece of schedule information out of the first schedule information and the second schedule information, based on the starting time or the ending time set to each piece of the first schedule information and the second schedule information, and
executes display based on the selected schedule information.

### BRIEF DESCRIPTION OF THE DRAWINGS

A more complete understanding of this application can be obtained when the following detailed description is considered in conjunction with the following drawings, in which:

FIG. 1 is a diagram illustrating an electronic watch and a terminal device according to an embodiment of the present disclosure;

FIG. 2 is a block diagram illustrating a configuration of a display device according to the embodiment of the present disclosure;

FIG. 3 is a block diagram illustrating a configuration of the terminal device according to the embodiment of the present disclosure;

FIG. 4 is a flowchart illustrating schedule information transmission processing according to the embodiment of the present disclosure;

FIG. 5 is a flowchart illustrating display processing according to the embodiment of the present disclosure;

FIG. 6 is a flowchart illustrating first schedule selection display processing according to the embodiment of the present disclosure;

FIG. 7 is a flowchart illustrating second schedule selection display processing according to the embodiment of the present disclosure;

FIG. 8 is a diagram illustrating schedule information according to the embodiment of the present disclosure; and

FIG. 9 is a diagram illustrating a display on the electronic watch according to the embodiment of the present disclosure.

### DETAILED DESCRIPTION

A display device and an electronic watch according to an embodiment of the present disclosure will be described below referring to drawings.

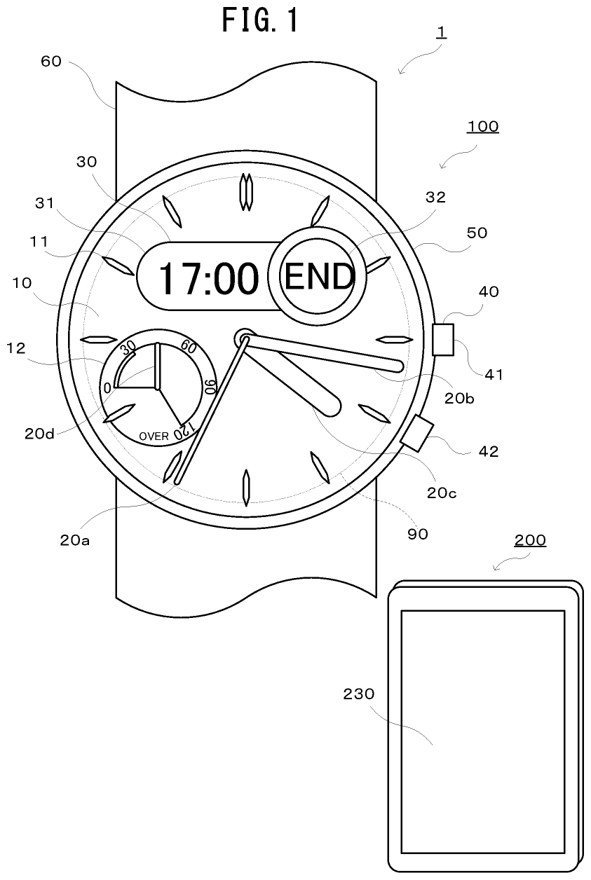

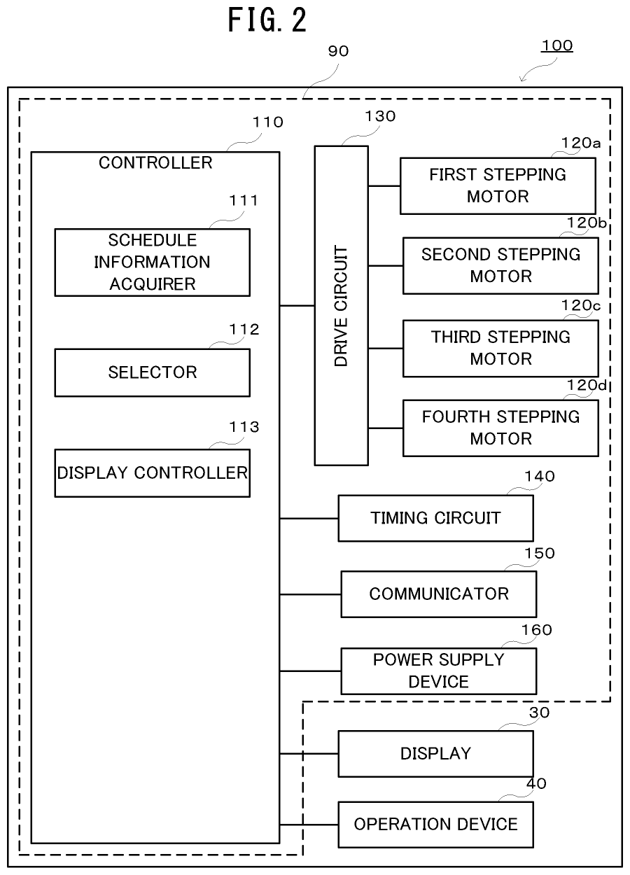

An electronic watch 1 according to the present embodiment is a watch including a dial 10, hands 20a to 20d, a display 30, an operation device 40, a case 50, a band 60, and a drive device 90, as illustrated in FIG. 1. The electronic watch 1 acquires a plurality of pieces of schedule information each being transmitted from a terminal device 200 and including information of a starting time and information of an ending time and displays schedule information. The dial 10, the hands 20a to 20d, the display 30, the operation device 40, the case 50, the band 60, and the drive device 90 constitute a display device 100. The drive device 90 includes first to fourth stepping motors 120a to 120d, a drive circuit 130, a timing circuit 140, a communicator 150, a power supply device 160, and a controller 110, as illustrated in FIG. 2.

The dial 10 illustrated in FIG. 1 is an indicator panel including a main dial 11 indicating the present time and a sub-dial indicating a time remaining until an ending time. The sub-dial 12 fanwise displays a time indicating a remaining time ranging from 0 to 120 minutes and further displays “OVER” being a display indicating that the remaining time exceeds 120 minutes being a preset reference time.

The hand 20a is a second hand indicating seconds, the hand 20b is a minute hand indicating minutes, the hand 20c is an hour hand indicating hours, and the hand 20d is a retrograde hand indicating a remaining time. The hands 20a to 20c are rotatably provided with respect to the rotation axis of the main dial 11. The hand 20d is provided in a fanwise reciprocatively movable manner in clockwise and counterclockwise directions with respect to the rotation axis of the sub-dial 12. The hand 20d indicates a remaining time fanwise displayed on the sub-dial 12 or “OVER” being a display indicating that the remaining time exceeds 120 minutes being the preset reference time. The dial 10 and the hands 20a to 20d are an example of a first display constituting a hand display.

The display 30 is a digital display displaying a plurality of numerals or characters and is configured with a liquid crystal display (LCD), an organic electro-luminescence (EL), or the like. The display 30 is an example of a second display and includes a first display 31 digitally displaying the present time or an ending time, and a second display 32 digitally displaying characters.

The operation device 40 receives an instruction to perform display switching or mode switching in accordance with a user input. The operation device 40 includes a first button 41 and a second button 42.

The case 50 includes a cover glass covering the dial 10 and the hands 20a to 20d and houses the hands 20a to 20d, the dial 10, and the drive device 90. The band 60 is attached to the case 50 and is to be worn on a wrist being a user's body. The band 60 functions as an attacher.

The first stepping motor 120a illustrated in FIG. 2 drives the hand 20a being a second hand through one or a plurality of gears. The second stepping motor 120b drives the hand 20b being a minute hand through one or a plurality of gears. The third stepping motor 120c drives the hand 20c being an hour hand through one or a plurality of gears. The hands 20a to 20c display the present time with the configuration. The fourth stepping motor 120d drives the hand 20d being a hand indicating a remaining time, through one or a plurality of gears.

The drive circuit 130 drives the first to fourth stepping motors 120a to 120d in accordance with an instruction from the controller 110.

The timing circuit 140 is a counter circuit including an oscillator circuit and a frequency dividing circuit and counting the present time; and a circuit oscillating in combination with an oscillator such as crystal is used as the oscillator circuit, and the oscillator circuit generates a unique frequency signal and outputs the signal to the frequency dividing circuit. The frequency dividing circuit divides a signal input from the oscillator circuit into frequency signals and outputs the signals. The timing circuit 140 counts the number of times a predetermined frequency signal is output from the frequency dividing circuit and counts the present time by adding the number to an initial time. Further, the timing circuit 140 corrects the present time, based on time information received by the communicator 150.

The communicator 150 receives a plurality of pieces of schedule information each being transmitted from the terminal device 200 and including information of a starting time and information of an ending time, and time information. The time information includes time information transmitted from a Global Positioning System (GPS) satellite and time information provided by a standard time and frequency radio wave. The communicator 150 is configured with a wireless communication module such as a wireless local area network (LAN) or Bluetooth (registered trademark).

The power supply device 160 includes a battery and a DC-DC converter and is configured to be able to keep output voltage constant during operation and operate the display device 100 continuously and stably for a long period.

The controller (processor) 110 includes a central processing unit (CPU), a read only memory (ROM), and a random access memory (RAM). The controller 110 functions as a schedule information acquirer 111, a selector 112, and a display controller 113 by reading a program stored in the ROM into the RAM and executing the program.

The schedule information acquirer 111 acquires a plurality of pieces of schedule information each being transmitted from the terminal device 200 and including information of a starting time and information of an ending time and updates schedule information stored in the RAM to a plurality of pieces of schedule information, the ending time of each is set to a time within a set time from the present time. For example, the plurality of pieces of schedule information includes first schedule information and second schedule information. For example, the set time is 24 hours. Specifically, when a reference period elapses after transmission of the last transmission request information, the schedule information acquirer 111 transmits transmission request information to the terminal device 200 and receives a plurality of pieces of schedule information each being transmitted from the terminal device 200 and including information of a starting time and information of an ending time.

When determining that a plurality of pieces of schedule information in progress exists in the plurality of pieces of schedule information stored in the RAM, the selector 112 selects one piece of schedule information out of the plurality of pieces of schedule information, based on a starting time or an ending time set to each of the plurality of pieces of schedule information. Specifically, the selector 112 selects schedule information including information of the latest starting time out of the pieces of schedule information in progress. A schedule, schedule information of which includes information of a starting time earlier than the present time and information of an ending time later than the present time, is herein assumed to be a schedule in progress, and whether a plurality of pieces of schedule information, respective periods of which at least partially overlap each other, each period ranging from a starting time to an ending time, exists is determined. For example, when the pieces of schedule information in progress include first schedule information and second schedule information, the selector 112 selects schedule information including information of the latest starting time out of the first schedule information and the second schedule information. Further, when determining that a plurality of pieces of schedule information including information of the latest starting time exists in the selected pieces of schedule information, the selector 112 selects schedule information including information of the earliest ending time out of the selected pieces of schedule information. For example, when the first schedule information and the second schedule information include information of the same starting time, the selector 112 selects schedule information including information of the earliest ending time out of the first schedule information and the second schedule information. Further, when determining that one piece of schedule information in progress exists, the selector 112 selects the schedule information. When determining that schedule information in progress does not exist, the selector 112 selects schedule information including information of the earliest starting time out of the pieces of schedule information stored in the RAM and sets a period until the starting time of the next schedule as a temporary schedule. In this case, the selector 112 sets the starting time of the next schedule as the ending time of the temporary schedule.

The display controller 113 displays an ending time on the first display 31, based on schedule information or a temporary schedule selected by the selector 112, the schedule information including first schedule information and second schedule information. Further, the display controller 113 displays the time remaining between the present time and the ending time by the hand 20d, based on the schedule information or the temporary schedule selected by the selector 112. Specifically, the display controller 113 drives the fourth stepping motor 120d by controlling the drive circuit 130 and causes the hand 20d to indicate the time remaining until the ending time displayed on the sub-dial 12 or “OVER” indicating that the remaining time exceeds 120 minutes.

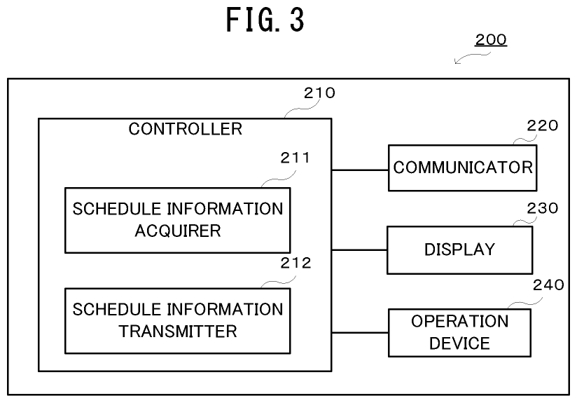

As illustrated in FIG. 3, the terminal device 200 includes a controller 210, a communicator 220, a display 230, an operation device 240, a ROM, and a RAM. For example, the terminal device 200 is configured with a smartphone or a tablet personal computer (PC). The ROM is configured with a nonvolatile memory such as a flash memory and stores a program for the controller 210 to provide various functions. The RAM is configured with a volatile memory and is used as a work area for the controller 210 to execute a program for performing various types of processing. The RAM further stores a plurality of pieces of schedule information each including information of a starting time and information of an ending time.

The controller 210 is configured with a CPU or the like. The controller 210 functions as a schedule information acquirer 211 and a schedule information transmitter 212 by executing a program stored in the ROM.

The schedule information acquirer 211 acquires a plurality of pieces of schedule information each including information of a starting time and information of an ending time and being acquired by the operation device 240 or received by the communicator 220 and stores the schedule information into the RAM.

When determining that transmission request information transmitted from the display device 100 is received, the schedule information transmitter 212 transmits a plurality of pieces of schedule information each including information of a starting time and information of an ending time to the display device 100 through the communicator 220.

The communicator 220 transmits data representing a plurality of pieces of schedule information each including information of a starting time and information of an ending time to the display device 100. The communicator 220 is configured with a wireless communication module such as a wireless LAN or Bluetooth (registered trademark), similarly to the aforementioned communicator 150.

The display 230 displays a plurality of pieces of input schedule information each including information of a starting time and information of an ending time, and an image required for operation and is configured with an LCD, an organic EL, or the like.

The operation device 240 receives a plurality of pieces of schedule information each including information of a starting time and information of an ending time, in accordance with a user input. The operation device 240 and the display 230 constitute a touch panel display device.

Next, processing executed by the display device 100 and the terminal device 200 that are configured as described above will be described.

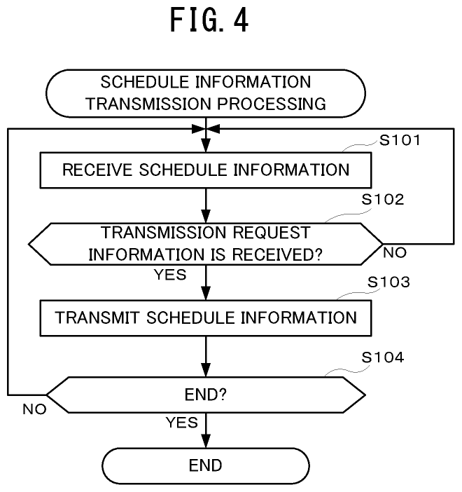

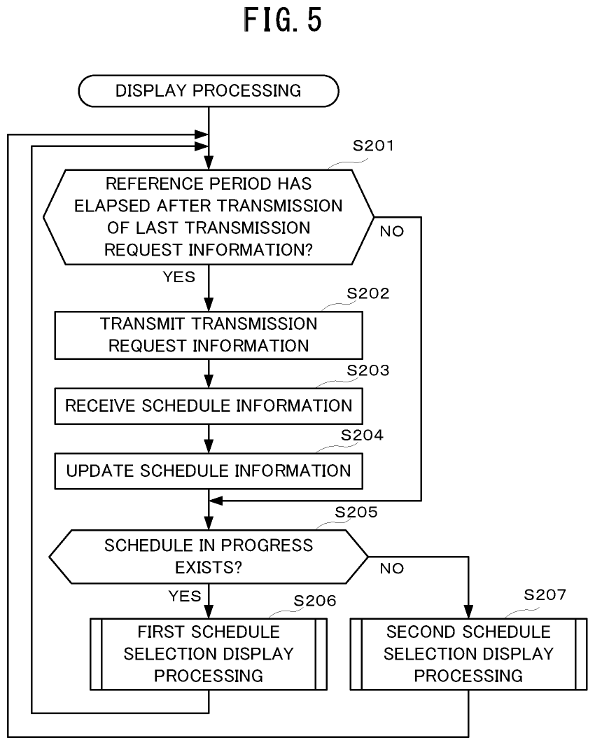

In response to an instruction to start processing given by a user, the terminal device 200 starts schedule information transmission processing illustrated in FIG. 4. In response to an instruction to start processing given by a user, the display device 100 starts display processing illustrated in FIG. 5. The schedule information transmission processing executed by the terminal device 200 and the display processing executed by the display device 100 will be described below by use of flowcharts.

When the schedule information transmission processing is started, the schedule information acquirer 211 acquires a plurality of pieces of schedule information each including information of a starting time and information of an ending time and being acquired by the operation device 240 or received by the communicator 220 and stores the schedule information into the RAM (Step S101). Next, the schedule information transmitter 212 determines whether transmission request information transmitted from the display device 100 is received (Step S102).

When determining that transmission request information is not received (Step S102: NO), the schedule information transmitter 212 returns to Step S101 and repeats Step S101 and Step S102. When determining that transmission request information is received (Step S102: YES), the schedule information transmitter 212 transmits a plurality of pieces of schedule information each including information of a starting time and information of an ending time to the display device 100 through the communicator 220 (Step S103).

Next, the schedule information transmitter 212 determines whether an instruction to end the schedule information transmission processing is input (Step S104). When an instruction to end the schedule information transmission processing is not input (Step S104: NO), the schedule information transmitter 212 returns to Step S101 and repeats Step S101 to Step S104. When an instruction to end the schedule information transmission processing is input (Step S104: YES), the schedule information transmitter 212 ends the schedule information transmission processing.

When the display processing is started, the schedule information acquirer 111 in the display device 100 determines whether a reference period has elapsed after transmission of the last transmission request information (Step S201). For example, the reference period is 5 minutes. When determining that the reference period has not elapsed after transmission of the last transmission request information (Step S201: NO), the schedule information acquirer 111 advances to Step S205. When determining that the reference period has elapsed after transmission of the last transmission request information (Step S201: YES), the schedule information acquirer 111 transmits transmission request information to the terminal device 200 through the communicator 220 (Step S202).

Next, the schedule information acquirer 111 receives a plurality of pieces of schedule information each being transmitted from the terminal device 200 and including information of a starting time and information of an ending time (Step S203). The schedule information acquirer 111 updates schedule information stored in the RAM to a plurality of pieces of schedule information, the ending time of each is set to a time within a set time from the present time, in the plurality of pieces of received schedule information (Step S204). For example, the set time is 24 hours.

Next, the selector 112 determines whether schedule information in progress exists in the plurality of pieces of schedule information stored in the RAM (Step S205). A schedule, schedule information of which includes information of a starting time earlier than the present time and information of an ending time later than the present time, is herein assumed to be a schedule in progress. When determining that a schedule in progress exists (Step S205: YES), the selector 112 executes first schedule selection display processing (Step S206).

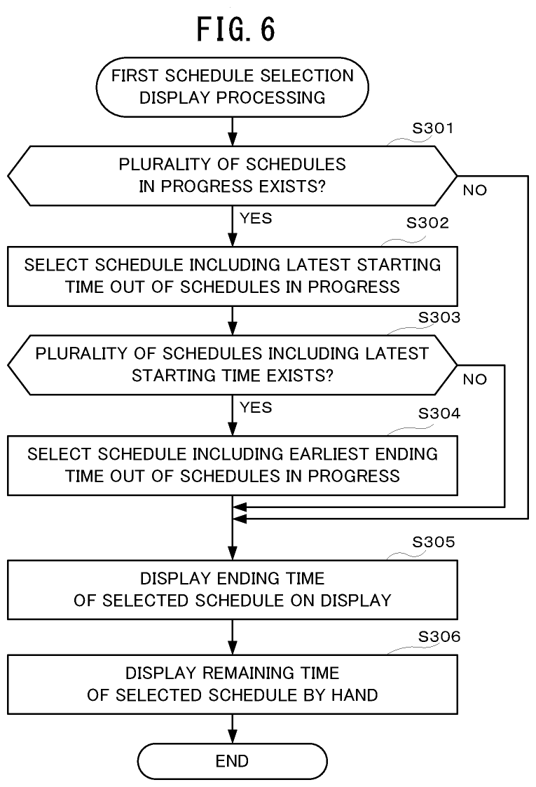

When the first schedule selection display processing illustrated in FIG. 6 is executed, the selector 112 determines whether a plurality of pieces of schedule information in progress exists (Step S301). When determining that a plurality of pieces of schedule information in progress exists (Step S301: YES), the selector 112 selects schedule information including information of the latest starting time out of the pieces of schedule information in progress (Step S302). When determining that a plurality of pieces of schedule information in progress does not exist (Step S301: NO), the selector 112 advances to Step S305. Next, the selector 112 determines whether a plurality of pieces of schedule information including information of the latest starting time exists in one or a plurality of pieces of the selected schedule information (Step S303). When determining that a plurality of pieces of schedule information including information of the latest starting time exists (Step S303: YES), the selector 112 selects schedule information including information of the earliest ending time out of the selected pieces of schedule information (Step S304). When determining that a plurality of pieces of schedule information including information of the latest starting time does not exist in the one or a plurality of pieces of the selected schedule information (Step S303: NO), the selector 112 advances to Step S305.

Next, the display controller 113 displays the ending time on the first display 31, based on the schedule information selected by the selector 112 (Step S305). Next, the display controller 113 displays the time remaining between the present time and the ending time by the hand 20d, based on the schedule information selected by the selector 112 (Step S306). Specifically, the display controller 113 drives the fourth stepping motor 120d by controlling the drive circuit 130 and causes the hand 20d to indicate the time remaining until the ending time displayed on the sub-dial 12 or “OVER” indicating that the remaining time exceeds 120 minutes. Subsequently, the display controller 113 returns to the display processing illustrated in FIG. 5 and repeats Step S201 to Step S207.

When determining that a schedule in progress does not exist (Step S205: NO), the selector 112 executes second schedule selection display processing (Step S207).

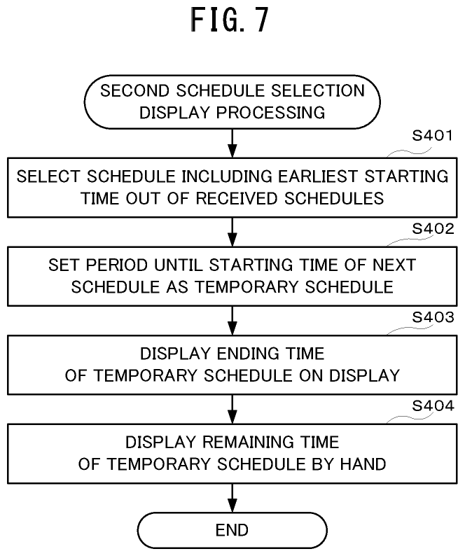

When the second schedule selection display processing illustrated in FIG. 7 is executed, the selector 112 selects schedule information including information of the earliest starting time out of the pieces of schedule information stored in the RAM (Step S401). Next, the selector 112 sets a period until the starting time of the next schedule as a temporary schedule (Step S402). In this case, the selector 112 sets the starting time of the next schedule as the ending time of the temporary schedule.

Next, the display controller 113 displays the ending time of the temporary schedule on the first display 31 (Step S403). Next, the display controller 113 displays the time remaining between the present time and the ending time of the temporary schedule by the hand 20d (Step S404). Subsequently, the display controller 113 returns to the display processing illustrated in FIG. 5.

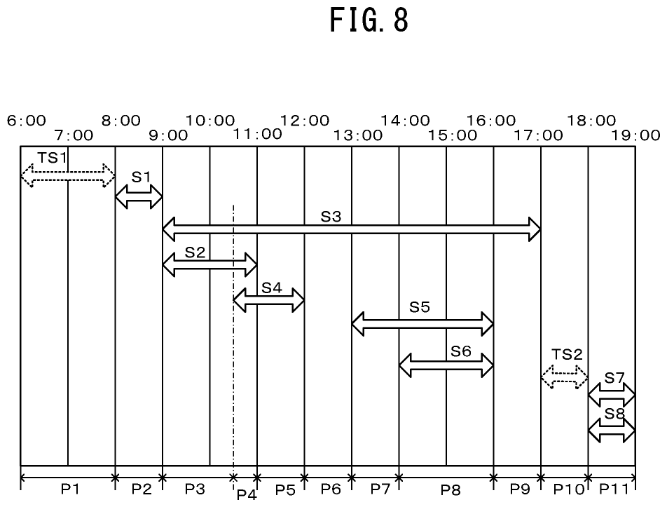

Next, the display processing executed by the display device 100 in an example of schedule information illustrated in FIG. 8 being input to the terminal device 200 will be described. The schedule information includes a schedule S1 to a schedule S8 each being set with a starting time and an ending time. A period P1 and a period P10 are periods in which no schedule is set.

The period P1 is a period in which no schedule is set. Therefore, when the present time is included in the period P1, schedule information in progress is determined not to exist (Step S205: NO in FIG. 5), and a period until the starting time of the schedule S1 being schedule information including information of the earliest starting time is set as a temporary schedule TS1 (Step S402 in FIG. 7). Next, the display controller 113 displays “8:00” being the ending time of the temporary schedule TS1 on the first display 31 (Step S403 in FIG. 7) and displays the time remaining between the present time and the ending time of the temporary schedule by the hand 20d (Step S404 in FIG. 7).

A period P2 is a period in which only the schedule S1 is set. Therefore, when the present time is included in the period P2, the selector 112 determines that a plurality of pieces of schedule information in progress does not exist and selects the schedule S1 (Step S301: NO in FIG. 6). The display controller 113 displays “9:00” being the ending time of the schedule 51 on the first display 31 (Step S305 in FIG. 6) and displays the time remaining between the present time and the ending time of the schedule S1 by the hand 20d (Step S306 in FIG. 6).

The schedules S2 and S3 are set in a period P3. Therefore, when the present time is included in the period P3, a plurality of pieces of schedule information in progress is determined to exist (Step S301: YES in FIG. 6), and the selector 112 selects schedule information including information of the latest starting time out of the pieces of schedule information in progress (Step S302 in FIG. 6). In this case, the starting times of the schedules S2 and S3 are the same, and therefore the selector 112 selects the schedules S2 and S3. Since the schedules S2 and S3 are selected, a plurality of pieces of schedule information each including information of the latest starting time is determined to exist (Step S303: YES in FIG. 6); and the selector 112 selects the schedule S2 including the earliest ending time out of the schedules S2 and S3 (Step S304 in FIG. 6). The display controller 113 displays “11:00” being the ending time of the schedule S2 on the first display 31 (Step S305 in FIG. 6) and displays the time remaining between the present time and the ending time of the schedule S2 by the hand 20d (Step S306 in FIG. 6).

The schedules S2 to S4 are set in a period P4. When the present time is included in the period P4, the selector 112 selects the schedule S4 being schedule information including information of the latest starting time out of the pieces of schedule information in progress (Step S302 in FIG. 6). The display controller 113 displays “12:00” being the ending time of the schedule S4 on the first display 31 (Step S305 in FIG. 6) and displays the time remaining between the present time and the ending time of the schedule S4 by the hand 20d (Step S306 in FIG. 6).

The schedules S3 and S4 are set in a period P5. Therefore, when the present time is included in the period P5, the selector 112 selects the schedule S4 being schedule information including information of the latest starting time out of the pieces of schedule information in progress (Step S302 in FIG. 6). The remaining processing is executed similarly to the period P4.

A period P6 is a period in which only the schedule S3 is set. When the present time is included in the period P6, the selector 112 determines that a plurality of pieces of schedule information in progress does not exist and selects the schedule S3 (Step S301: NO in FIG. 6). The display controller 113 displays “17:00” being the ending time of the schedule S3 on the first display 31 (Step S305 in FIG. 6) and causes the hand 20d to indicate “OVER” indicating that the time remaining between the present time and the ending time of the schedule S3 exceeds 120 minutes (Step S306 in FIG. 6).

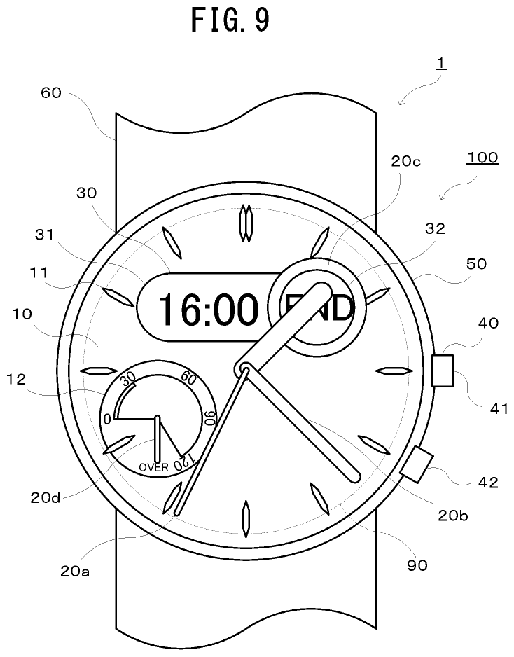

The schedules S3 and S5 are set in a period P7. Therefore, when the present time is included in the period P7, the selector 112 selects the schedule S5 being schedule information including information of the latest starting time out of the pieces of schedule information in progress (Step S302 in FIG. 6). As illustrated in FIG. 9, the display controller 113 displays “16:00” being the ending time of the schedule S5 on the first display 31 (Step S305 in FIG. 6) and causes the hand 20d to indicate “OVER” indicating that the time remaining between the present time and the ending time of the schedule S5 exceeds 120 minutes (Step S306 in FIG. 6).

The schedules S3, S5, and S6 are set in a period P8. Therefore, when the present time is included in the period P8, the selector 112 selects the schedule S6 being schedule information including information of the latest starting time out of the pieces of schedule information in progress (Step S302 in FIG. 6). The display controller 113 displays “16:00” being the ending time of the schedule S6 on the first display 31 (Step S305 in FIG. 6) and displays the time remaining between the present time and the ending time of the schedule S6 by the hand 20d (Step S306 in FIG. 6).

A period P9 is a period in which only the schedule S3 is set. When the present time is included in the period P9, processing similar to that in the period P6 is executed. As illustrated in FIG. 1, the display controller 113 displays “17:00” being the ending time of the schedule S3 on the first display 31 (Step S305 in FIG. 6) and displays the time remaining between the present time and the ending time of the schedule S3 by the hand 20d (Step S306 in FIG. 6).

The period P10 is a period in which no schedule is set. When the present time is included in the period P10, a period until the starting time of the schedules S7 and S8 is set as a temporary schedule TS2 (Step S402 in FIG. 7). The remaining processing is executed similarly to the period P1.

The schedules S7 and S8 are set in a period P11. Therefore, when the present time included in the period P11, the selector 112 selects schedule information including information of the latest starting time out of the pieces of schedule information in progress (Step S302 in FIG. 6). In this case, the starting times of the schedules S7 and S8 are the same, and therefore the selector 112 selects the schedules S7 and S8. Since the schedules S7 and S8 are selected, a plurality of pieces of schedule information including information of the latest starting time is determined to exist (Step S303: YES in FIG. 6), and the selector 112 selects schedule information including information of the earliest ending time out of the schedules S7 and S8 (Step S304 in FIG. 6). In this case, the ending times of the schedules S7 and S8 are the same, and therefore the schedules S7 and S8 are selected, and the display controller 113 displays “19:00” being the ending time of the schedules S7 and S8 on the first display 31 (Step S305 in FIG. 6) and displays the time remaining between the present time and the ending time of the schedules S7 and S8 by the hand 20d (Step S306 in FIG. 6).

As described above, when a plurality of pieces of schedule information is in progress, the electronic watch 1 and the display device 100 according to the present embodiment can select schedule information including information of the latest starting time and information of the earliest ending time and can digitally display an ending time included in the selected schedule information on the first display 31 and perform countdown display of the remaining time by the hand 20d. Thus, an ongoing schedule with the highest real time property can be automatically selected, and a model with a poor displaying ability can allow a user to recognize important schedule information. Further, a user can intuitively learn a remaining time by displaying the remaining time by the hand 20d, and can accurately learn an ending time by digitally displaying the ending time on the first display 31. Further, as long as the schedule information acquirer 111 is connected to the terminal device 200, the schedule information acquirer 111 can automatically update schedule information by receiving one or a plurality of pieces of schedule information each being transmitted from the terminal device 200 and including information of a starting time and information of an ending time every time a reference period elapses; and therefore user convenience is improved.

Since an amount of information that can be displayed on a dial digitally or by a hand is small, a display device or an electronic watch displaying a time needs to select information to be displayed. The display device disclosed in Unexamined Japanese Patent Application Publication No. 2011-67281 requires a user to select which of a temporary room exit reason, a room exiting time, a scheduled measurement resumption time, and present lapse information is to be displayed and has a problem that the operation is time-consuming.

The present disclosure is configured as described above and therefore can display suitable schedule information without selection by a user.

### Modified Example

An example of the display controller 113 displaying only an ending time on the first display 31 has been described in the aforementioned embodiment. The display controller 113 has only to be able to display information useful to a user in schedule information on the first display 31. For example, the display controller 113 may display the ending time of a schedule in progress on the first display 31 when it takes 10 minutes being a reference remaining time or more to reach the ending time and may display the time remaining until the ending time of the schedule in progress by per-second countdown on the first display 31 when it takes less than 10 minutes to reach the ending time. Thus, when the ending time is approaching, a user can learn an accurate remaining time by a digital display.

While an example of the display controller 113 always displaying an ending time or a remaining time on the first display 31 has been described in the aforementioned embodiment, an ending time or a remaining time may be displayed on the first display 31 when the first button 41 is pressed. Specifically, in a case of the first button 41 being pressed, the display controller 113 may display the ending time of a schedule in progress on the first display 31 when it takes 10 minutes or more to reach the ending time and may display “SOON” indicating that the ending time of the schedule in progress is approaching on the first display 31 when it takes less than 10 minutes to reach the ending time (for example, a display time of “SOON” is one second); and the display controller 113 may subsequently perform per-second countdown display of the time remaining until the ending time of the schedule in progress. Thus, by a user merely pressing the first button 41, a display of “the ending time of a schedule in progress” on the first display 31 is switched to a display of “per-second countdown until the ending time” when the remaining time of the schedule in progress until the end becomes 10 minutes or less. The display allows a user to recognize that the ending time of the schedule is approaching and further recognize the remaining time until the schedule ends; and therefore convenience is improved. In this case, the first display 31 is set to display the present time or the date before the first button 41 is pressed. Thus, a user can confirm the present time or the date by the first display 31 and further can confirm the ending time or the time remaining until the ending time displayed on the first display 31 merely by pressing the first button 41.

An example of the schedule information acquirer 111 updating schedule information stored in the RAM to schedule information, the ending time of which is set to a time within 24 hours from the present time, has been described in the aforementioned embodiment. The schedule information acquirer 111 may store schedule information according to capacity of the RAM. For example, the schedule information acquirer 111 may store a reference number of pieces of schedule information to be stored in the RAM. For example, the reference number is five. Thus, an area of the RAM storing schedule information can be reduced. Even in this case, schedule information can be automatically updated as long as the schedule information acquirer 111 is connected to the terminal device 200, and therefore occurrence of a problem that schedule information is not stored in the display device 100 can be prevented.

While schedule information is notified to a user only by display in the aforementioned embodiment, a user may be notified of the present time reaching a starting time or an ending time included in schedule information by sound. Further, different sounds may be generated for a starting time and an ending time, respectively, in such a way that a user can hear the difference between the starting time and the ending time; and thus convenience may be improved.

While an example of the schedule information acquirer 111 receiving schedule information every time a reference period elapses has been described in the aforementioned embodiment, the schedule information acquirer 111 may receive schedule information in response to a user operation. Thus, the schedule information acquirer 111 can receive schedule information by a user operation at a timing when the user inputs the schedule information to the terminal device 200.

A case of the display device 100 being used as the electronic watch 1 has been described in the aforementioned embodiment. The display device 100 may be used in a device other than the electronic watch 1, such as a table clock.

Further, a main part performing hand movement control processing executed by the display device 100 including the CPU, the RAM, and the ROM can be executed by use of a common information portable terminal (a smartphone or a tablet PC), a personal computer, or the like instead of a dedicated system. For example, a computer program for executing the aforementioned operations may be stored in a non-transitory computer-readable recording medium [such as a flexible disk, a compact disc read only memory (CD-ROM), or a digital versatile disc read only memory (DVD-ROM)] and be distributed; and an information terminal executing the aforementioned processing may be configured by installing the computer program on an information portable terminal or the like. Further, the computer program may be stored in a storage device included in a server device on a communication network such as the Internet; and an information processing device may be configured by downloading the computer program to a common information processing terminal or the like.

When the display device 100 is provided by role sharing between an operating system (OS) and an application program, cooperation between an OS and an application program, or the like, only the application program part may be stored in a non-transitory recording medium or a storage device.

Further, a computer program can be superposed on a carrier wave and be delivered through a communication network. For example, the computer program may be posted on a bulletin board system (BBS) on a communication network, and the computer program may be delivered through the network. Then, the aforementioned processing may be executed by starting the computer program and executing the program similarly to other application programs under control of an OS.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A display device comprising at least one processor,
wherein the processor
acquires a plurality of pieces of schedule information each including information of a starting time and information of an ending time,
when first schedule information and second schedule information, respective periods of which at least partially overlap each other, each period ranging from the starting time to the ending time, exist, selects one piece of schedule information out of the first schedule information and the second schedule information, based on the starting time or the ending time set to each piece of the first schedule information and the second schedule information, and
executes display based on the selected schedule information.

2. The display device according to claim 1, wherein, when a plurality of pieces of schedule information including information of the starting time earlier than a present time and information of the ending time later than the present time exists in the acquired first schedule information and the acquired second schedule information, the processor selects schedule information including information of the latest starting time out of the plurality of pieces of schedule information.

3. The display device according to claim 1, wherein, when a plurality of pieces of schedule information including information of the starting time earlier than a present time and information of the ending time later than the present time exists in the acquired first schedule information and the acquired second schedule information and the plurality of pieces of schedule information includes information of the same starting time, the processor selects schedule information including information of the earliest ending time out of the plurality of pieces of schedule information.

4. The display device according to claim 1, wherein the processor displays the ending time included in the selected schedule information or a time remaining until the ending time.

5. The display device according to claim 1, wherein the processor acquires schedule information, the ending time of which is set to a time within a set time from a present time.

6. The display device according to claim 1, further comprising a first display displaying a time remaining until the ending time,
wherein the processor displays a time remaining between a present time and the ending time included in the selected schedule information by the first display.

7. The display device according to claim 6,
wherein the first display includes:
a sub-dial; and
a hand provided in a reciprocatively movable manner in clockwise and counterclockwise directions with respect to a rotation axis of the sub-dial.

8. The display device according to claim 6, wherein, when a remaining time exceeds a preset reference time, the first display displays that the remaining time exceeds the preset reference time.

9. The display device according to claim 1, further comprising a second display capable of digital display,
wherein the processor displays the ending time included in the selected schedule information on the second display.

10. The display device according to claim 1, further comprising a second display capable of digital display,
wherein the processor displays a time remaining until the ending time included in the selected schedule information on the second display.

11. The display device according to claim 1, further comprising:
a first display including a hand; and
a second display capable of digital display,
wherein the processor displays a time remaining until the ending time included in the selected schedule information on the first display and displays the ending time included in the schedule information or a time remaining until the ending time on the second display.

12. An electronic watch comprising:
the display device according to claim 1; and
an attacher attaching the display device to a user's body.

13. A display method comprising, by use of a display device including at least one processor:
acquiring a plurality of pieces of schedule information each including information of a starting time and information of an ending time;
when first schedule information and second schedule information, respective periods of which at least partially overlap each other, each period ranging from the starting time to the ending time, exist, selecting one piece of schedule information out of the first schedule information and the second schedule information, based on the starting time or the ending time set to each piece of the first schedule information and the second schedule information; and
executing display based on the selected schedule information.

14. The display method according to claim 13, further comprising, when a plurality of pieces of schedule information including information of the starting time earlier than a present time and information of the ending time later than the present time exists in the acquired first schedule information and the acquired second schedule information, selecting schedule information including information of the latest starting time out of the plurality of pieces of schedule information.

15. The display method according to claim 13, further comprising, when a plurality of pieces of schedule information including information of the starting time earlier than a present time and information of the ending time later than the present time exists in the acquired first schedule information and the acquired second schedule information and the plurality of pieces of schedule information includes information of the same starting time, selecting schedule information including information of the earliest ending time out of the plurality of pieces of schedule information.

16. The display method according to claim 13, further comprising displaying the ending time included in the selected schedule information or a time remaining until the ending time.

17. The display method according to claim 13, further comprising acquiring schedule information, the ending time of which is set to a time within a set time from a present time.

18. The display method according to claim 13, wherein
the display device further includes a first display displaying a time remaining until the ending time, and
the processor displays a time remaining between a present time and the ending time included in the selected schedule information by the first display.

19. The display method according to claim 18,
wherein the first display includes:
a sub-dial; and
a hand provided in a reciprocatively movable manner in clockwise and counterclockwise directions with respect to a rotation axis of the sub-dial.

20. A non-transitory recording medium storing a program causing a processor controlling a display device including at least one processor to function as a processor:
acquiring a plurality of pieces of schedule information each including information of a starting time and information of an ending time;
when first schedule information and second schedule information, respective periods of which at least partially overlap each other, each period ranging from the starting time to the ending time, exist, selecting one piece of schedule information out of the first schedule information and the second schedule information, based on the starting time or the ending time set to each piece of the first schedule information and the second schedule information; and
executing display based on the selected schedule information.
